(19) United States
(12) Patent Application Publication
(10) Pub. No.: US 2019/0043286 A1
(43) Pub. Date: Feb. 7, 2019

(54) USER IDENTIFICATION CARD CONTROL METHOD, TERMINAL, AND COMPUTER STORAGE MEDIUM

(71) Applicant: NUBIA TECHNOLOGY CO., LTD., Shenzhen (CN)

(72) Inventors: Jian HE, Shenzhen (CN); Zudong LUO, Shenzhen (CN)

(21) Appl. No.: 16/073,116

(22) PCT Filed: Jul. 14, 2016
(86) PCT No.: PCT/CN2016/090071

§ 371 Date: Jul. 26, 2018

(30) Foreign Application Priority Data
Jan. 28, 2016 (CN) 201610059290.6

(51) Int. Cl. G07C 9/00; G06K 19/04; G06K 7/10

(52) U.S. Cl. CPC G07C 9/00119; G06K 7/10415; G06K 19/042

(57) ABSTRACT

The present invention discloses a user identification card control method, a terminal, and a computer storage medium. The user identification card control method include: when intercommunication with a user identification card is needed, generating an access request; based on the access request, querying the access permission of the corresponding user identification card and, in response to having the access permission of the user identification card, controlling the connection path of the user identification card to be turned on to implement the intercommunication with the user identification card. The beneficial effect of implementing the present invention is that two processors can control and intercommunicate with two user identification cards, and thus achieve flexible access to the two user identification cards by the two processors.

This application is a national phase of PCT application No. PCT/CN2016/090071, filed on Jul. 14, 2016, which claims the priority of Chinese Patent Application No. CN2016100592906.0, filed on Jan. 28, 2016, the entire content of all of which is incorporated herein by reference.

### FIELD OF THE INVENTION

The present invention generally relates to the field of communication technology and, more particularly, relates to a user identification card control method, a terminal, and a computer storage medium.

### BACKGROUND

With the development of mobile communication technology, advanced cellular networks, e.g., networks based on the long-term evolution (LTE) standard (a standard adopted by some “4G” networks), are being deployed all over the world. Due to the introduction of key technologies such as orthogonal frequency division multiplexing (OFDM), multi-input & multi-output (MIMO), etc., using 4G-related standards can significantly improve spectral efficiency and data transmission speed.

On the other hand, while the network speed and the band utilization are getting improved, the emergence of multi-mode terminals (terminals that have two user identification cards, for example, dual-card dual-active terminals) allow users to establish data service connection while having standby voice service.

However, the existing multi-mode terminals may not be able to implement message sharing for multiple user identification cards, and may not be able to flexibly control the user identification cards. In view of the drawback of the existing technology, improvement may be needed.

### BRIEF SUMMARY OF THE INVENTION

The following is an overview of the topic detailed in the disclosure. This summary is not intended to limit the scope of the claims.

The embodiments of the present invention provides a user identification card control method, a terminal, and a computer storage medium to at least solve the drawback of the existing technology.

In a first aspect, the embodiments of the present invention provide a user identification card control method, applied to a terminal including a first user identification card and a second user identification card. The terminal includes a first processor;

The method includes:
when the first processor needs to intercommunicate with the first user identification card or the second user identification card, generating an access request;
the first processor, based on the access request, querying the access permission of the user identification card and, in response to having the access permission of the user identification card, controlling the connection path of the user identification card and the first processor to be turned on to implement the intercommunication between the first processor and the user identification card.

In one embodiment, the terminal further includes a second processor connected with the first processor.

The method further includes:
when the second processor needs to intercommunicate with the first user identification card or the second user identification card, generating an access request and sending the access request to the first processor;
the first processor, based on the access request, querying the access permission of the user identification card and, in response to having the access permission of the user identification card, controlling the connection path between the user identification card and the second processor to be turned on to implement the intercommunication between the second processor and the user identification card.

In one embodiment, the method also includes:
when the connection path between the second processor and the first user identification card or the second user identification card is turned on, but intercommunication with the card is not performed within a second preset time, releasing the connection path.

In one embodiment, the method also includes:
when the connection path between the first processor and the first user identification card or the second user identification card is turned on, but intercommunication with the card is not performed within a first preset time, releasing the connection path.

In one embodiment, the method also includes:
based on the access request, when determining not having the access permission of the corresponding user identification card, putting the access request into a message queue, and waiting for a preset condition to be satisfied to re-query the access permission.

In a second aspect, the embodiments of the present invention provide a terminal, including:
a first user identification card;
a second user identification card;
a first processor, configured to when intercommunication with the first user identification card or the second user identification card is needed, generate an access request;
the first processor, further configured to, based on the access request, query the access permission of the user identification card and, in response to having the access permission of the user identification card, control the connection path between the user identification card and the first processor to be turned on to implement the intercommunication between the first processor and the user identification card.

In one embodiment, the terminal also includes a second processor connected to the first processor.

The second processor is configured to, when intercommunication with the first user identification card or the second user identification card is needed, generate an access request and send the access request to the first processor;

The first processor is further configured to, based on the access request, query the access permission of the user identification card and, in response to having the access permission of the user identification card, control the connection path between the user identification card and the second processor to be turned on to implement the intercommunication between the second processor and the user identification card.

In one embodiment, the terminal also includes:
a card controller.

The card controller is connected with the first processor, the second processor, the first user identification card, and the second user identification card, respectively;

The card controller is configured to, based on the control of the first processor, turn on the connection path between the first user identification card and the first processor and/or the second processor; and also configured to, based on the control of the first processor, turn on the connection path between the second user identification card and the first processor and/or the second processor.

In one embodiment, the card controller includes a first switch and a second switch, where:
the first switch is connected with the first processor and the first user identification card, respectively;
the second switch is connected with the first processor and the second user identification card, respectively.

In one embodiment, the first processor includes a first card driving module and a card control module.

The first card driving module is configured to, when the first processor needs to intercommunicate with the first user identification card or the second user identification card, generate an access request and send the access request to the card control module; and also configured to, when no card intercommunication instruction is received within a first preset time, send a release request to the card control module.

The card control module is configured to, based on the access request sent by the first card driving module, output a control message to control the first switch to turn on the connection path between the first user identification card and the first processor, and/or control the second switch to turn on the connection path between the second user identification card and the first processor.

The card control module is configured to, based on the release request sent by the first card driving module, output a control message to control the first switch to turn off the connection path between the first user identification card and the first processor, and/or control the second switch to turn off the connection path between the second user identification card and the first processor.

In one embodiment, the second processor includes a second card driving module.

The second card driving module is configured to, when the second processor needs to intercommunicate with the first user identification card or the second user identification card, generate an access request and send the access request to the card control module; and also configured to, when no card intercommunication instruction is received within a second preset time, send a release request to the card control module.

The card control module is configured to, based on the access request sent by the second card driving module, output a control message to control the first switch to turn on the connection path between the first user identification card and the second processor, and/or control the second switch to turn on the connection path between the second user identification card and the second processor.

The card control module is configured to, based on the release request sent by the second card driving module, output a control message to control the first switch to turn off the connection path between the first user identification card and the second processor, and/or control the second switch to turn off the connection path between the second user identification card and the second processor.

In one embodiment, the first processor is also configured to send a message to the first user identification card or the second user identification card at a preset time interval to determine whether the user identification card is in place.

When determining whether the first user identification card is in place, in response to the first user identification card not connected with the first processor, the first processor is further configured to send out a first control instruction to control the first switch to turn on the connection path between the first user identification card and the first processor.

When determining whether the second user identification card is in place, in response to the second user identification card not connected with the first processor, the first processor is further configured to send out a second control instruction to control the second switch to turn on the connection path between the second user identification card and the first processor.

In one embodiment, the second processor is also configured to send a message to the first user identification card or the second user identification card at a preset time interval to determine whether the user identification card is in place.

When determining whether the first user identification card is in place, in response to the first user identification card not connected with the second processor, the first processor is further configured to send out a first control instruction to control the first switch to turn on the connection path between the first user identification card and the second processor.

When determining whether the second user identification card is in place, in response to the second user identification card not connected with the second processor, the first processor is further configured to send out a second control instruction to control the second switch to turn on the connection path between the second user identification card and the second processor.

In a third aspect, the embodiments of the present invention provide a user identification card control method, including:
when intercommunication with a user identification card is needed, generating an access request;
based on the access request, querying the access permission of the corresponding user identification card and, in response to having the access permission of the user identification card, controlling the connection path of the user identification card to be turned on to implement the intercommunication with the user identification card.

In one embodiment, after the connection path of the user identification card is turned on, when no card intercommunication instruction is received within a preset time, the connection path is released.

In a fourth aspect, the embodiments of the present invention provides a terminal, including a first user identification card and a second user identification card, and further including:
a first processor, configured to output a first control instruction and a second control instruction according to an operation instruction of the user;
a first switch, configured to turn on the connection path between the first user identification card and the first processor or the second processor according to the first control instruction;
a second switch, configured to turn on the connection path between the second user identification card and the first processor or the second processor according to the second control instruction, wherein:
   when the first user identification card or the second user identification card is connected with the first processor, the first processor is further configured to establish a communication connection with a 4G network;
a second processor, configured to establish a communication connection with a 4G network when the first user identification card or the second user identification card is connected with the second processor.

In a fifth aspect, the embodiments of the present invention provides a computer storage medium. The computer storage medium may store computer-executable instructions. The computer-executable instructions include:
when a first processor needs to intercommunicate with a first user identification card or a second user identification card, generating an access request;
the first processor, based on the access request, querying the access permission of the user identification card and, in response to having the access permission of the user identification card, controlling the connection path of the user identification card and the first processor to be turned on to implement the intercommunication between the first processor and the user identification card.

In one embodiment, the computer-executable instructions further include:
when a second processor needs to intercommunicate with the first user identification card or the second user identification card, generating an access request and sending the access request to the first processor;
the first processor, based on the access request, querying the access permission of the user identification card and, in response to having the access permission of the user identification card, controlling the connection path of the user identification card and the second processor to be turned on to implement the intercommunication between the second processor and the user identification card.

In one embodiment, the computer-executable instructions also include:
when the connection path between the second processor and the first user identification card or the second user identification card is turned on, but intercommunication with the card is not performed within a second preset time, releasing the connection path.

In one embodiment, the computer-executable instructions also include:
based on the access request, when determining not having the access permission of the corresponding user identification card, putting the access request into a message queue, and waiting for a preset condition to be satisfied to re-query the access permission.

By adopting an embodiment of the present invention, two processors may be able to control and intercommunicate with two user identification cards, and flexible access to the user identification cards by the two processors may be achieved. Therefore, dual 4G is supported, which improves the user experience; data service transmission by dual 4G is supported, which greatly improves the data transmission speed; and through the switching between user identification cards, CS voice services of the first user identification card and the second user identification card can be both processed by the first processor, and thus only one codec and one digital signal processing chip are required. Logic for voice intercommunication between two processing chips is not required, data (voice) transmission between two processing chips is not required, and the cost of software and hardware is reduced.

### BRIEF DESCRIPTION OF THE DRAWINGS

The present invention will be further described in the following with reference to the accompanying drawings and embodiments. In the accompanying drawings:

FIG. 1 illustrates a schematic diagram of a terminal according to an embodiment of the present invention;

FIG. 2 illustrates a schematic diagram of a terminal according to an embodiment of the present invention;

FIG. 3 illustrates a detailed schematic diagram of a first processor and a second processor of a terminal according to an embodiment of the present invention;

FIG. 4 illustrates a schematic diagram of a hardware structure of a terminal according to an embodiment of the present invention;

FIG. 5 illustrates a schematic flow chart of a user identification card control method according to an embodiment of the present invention; and

FIG. 6 illustrates a schematic flow chart of a user identification card control method according to another embodiment of the present invention.

### DETAILED DESCRIPTION

In order to make the technical features, the objects, and the effects of the present invention more clearly understandable, specific embodiments of the present invention will now be explained in detail with reference to the accompanying drawings.

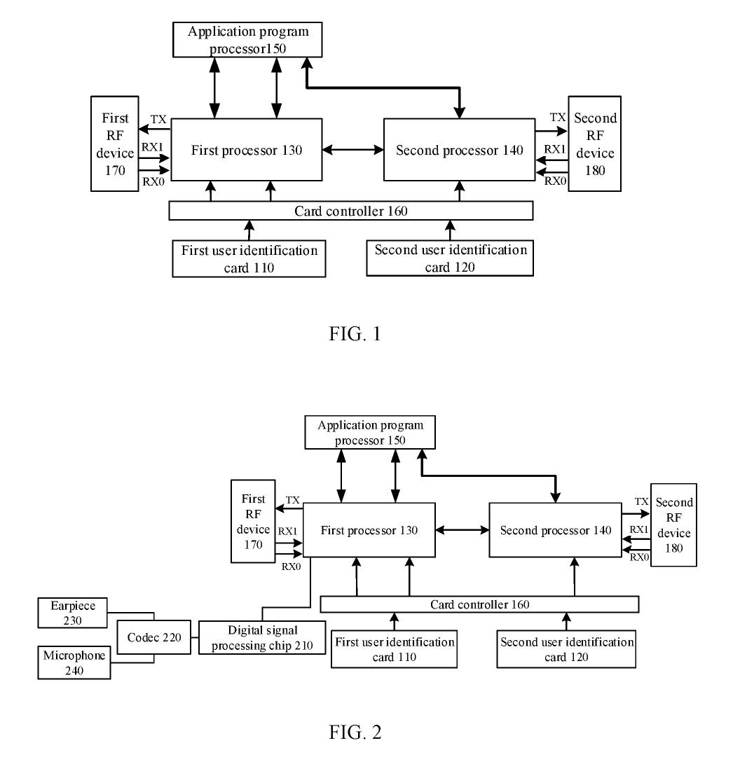

Referring to FIG. 1, a schematic diagram of a terminal according to an embodiment of the present invention is provided.

The terminal 100 according to the embodiment of the present invention includes: a first user identification card 110, a second user identification card 120, a first processor 130, a second processor 140, an application program processor 150, a card controller 160, a first radio frequency (RF) device 170, and a second RF device 180.

The first user identification card 110 may be disposed in a first card slot (not shown in FIG. 1). The second user identification card 120 may be disposed in a second card slot (not shown in FIG. 1). In one embodiment, the first card slot and the second card slot may adopt an “independent card slot” manner, that is, two independent card trays may be included for carrying the first user identification card and the second user identification card, respectively. In another embodiment, the first card slot and the second card slot may adopt a “one tray for two” manner, that is, only one card tray with two card slots may be included.

The user identification card according to the embodiments of the present invention may be used to identify and authenticate users for the network. For example, the user identification card may include a universal subscriber identity module (USIM), a subscriber identity module (SIM), etc. In some embodiments, the user identification card may store one or more of the following messages: an integrated circuit card identifier (ICCID), an international mobile subscriber identity (IMSI), a security authentication and encryption message, a temporary message related to the local network, a personal identification number (PIN), a personal unlocking key (PUK) for PIN unlocking.

The terminal 100 may include any mobile, portable computing or communication device, such as a cellular device, that is capable of connecting to a network. For example, the terminal 100 may be a cellular phone (mobile phone), a navigation system, a computing device, or a handheld device with wireless connection capability.

In an embodiment of the present invention, the terminal 100 may be a device that accesses a network based on subscription information in a user identification card. The first user identification card 110 may be associated with a first subscription, and the second user identification card 120 may be associated with a second subscription. The first subscription and the second subscription may be voice and/or data subscriptions. The first subscription and the second subscription may be associated with the same technology type, the same network operator, or associated with different technology types and/or different network operators. The technology type and/or network may include 4G technologies including, but not limited to, long term evolution (LTE), time division long term evolution (TD-LTE), EUTRAN (4G LTE), or any other fourth-generation mobile communication technology.

When performing network search and network registration, the type of the user identification card may be identified according to the information stored in the user identification card, such that the corresponding network parameters may be loaded to perform network search and network registration based on the type of the user identification card. Thus, the terminal 100 may use the first subscription associated with the first user identification card 110 for network communication, and also use the second subscription associated with the second user identification card 120 for network communication. It should be understood that the network parameters may include frequency bands, channel numbers, and other parameters required for network search and network registration. Different user identification cards may correspond to different operators, and the corresponding network parameters may also be different. For example, when the user identification card is determined to be China Mobile according to the IMSI, the corresponding network parameters of China Mobile may be loaded to complete the network registration.

The network parameters may be stored in a memory (not shown in FIG. 1). According to the embodiments of the present invention, the number of network parameters may be associated with the operators supported by the terminal. For example, when the terminal supports three major operators, the number of network parameters is thus three; when the terminal supports global communication, the number of the network parameter files may reach 217 (the number of global operators is 217).

The memory may be any available storage medium that can be accessed by a general or special purpose application. For example, the memory may include a random access memory (RAM), a read-only memory (ROM), an electrically erasable programmable read-only memory (EEPROM), a disk storage, or other magnetic storage devices.

The first processor 130 may be configured to complete the protocol processing, and also configured to perform modulation and demodulation on the transmitted and the received communication data to implement the communication with an external communication device, and other operations. Among them, the protocol processing may include the implementation of protocols that handle various network formats for network intercommunication, for example, protocol code specified in a communication standard such as LTE, wide band code division multiple access (WCDMA), global system for mobiles (GSM), time division synchronous code division multiple access (TDSCDMA), 1×, code division multiple access (CDMA), evolution-data optimized (EVDO). These standard protocols may be required for user devices to interact with the operator's network (for example, accessing the Internet through data traffic, calling via VOLTE, calling via the CS circuit domain, etc.).

The second processor 140 may be configured to complete the protocol processing, and also configured to perform modulation and demodulation on the transmitted and the received communication data to implement the communication with an external communication device, and other operations. Among them, the protocol processing may include the implementation of protocols that handle various network formats for network intercommunication, for example, protocol code specified in a communication standard such as LTE, WCDMA, GSM, TDSCDMA, 1×, CDMA, EVDO. These standard protocols may be required for user devices to interact with the operator's network (for example, accessing the Internet through data traffic, calling via VOLTE, calling via the CS circuit domain, etc.).

The first RF device 170 and the second RF device 180 may be configured to complete signal operations, such as up-conversion, down-conversion, filtering, amplification, transmission, receiving, etc. The wireless access technology that the first RF device 170 and the second RF device 180 are related to may include LTE, GSM, GPRS, and so on.

According to the embodiments of the present invention, the terminal 100 may be able to simultaneously use the data networks of the two user identification cards to download data services at the same time, such that the goal of accelerating dual data concurrent download may be achieved. Therefore, the same user identification card may need to be accessed by both the first processor 130 and the second processor 140. The term, access, used here may refer to obtaining the messages of the user identification cards to implement the network communication through the first subscription associated with the first user identification card 110 and also implement the network communication through the second subscription associated with the second user identification card 120.

Referring to FIG. 1, according to the embodiments of the present invention, the card controller 160 may be configured to, based on the control of the first processor 130, switch the connection path between the first user identification card 110 and the first processor 130, and also switch the connection path between the second user identification card 120 and the second processor 140, such that the first processor 130 may be able to acquire the message of the first user identification card 110 and also acquire the message of the second user identification card 120, and the second processor 140 may be able to acquire the message of the first user identification card 110 and also acquire the message of the second user identification card 120.

Therefore, the first user identification card 110 may be able to implement voice and/or data services through the first processor 130, the application program processor 150, etc., and the second user identification card 120 may be able to implement voice and/or data services through the first processor 130, the application program processor 150, etc.

It should be understood that, referring to FIG. 2, when processing voice services, the terminal of the embodiments of the present invention may also include an earpiece 230, a microphone 240, a codec 220, a digital signal processing chip 210, etc. The function of each component and the flow of the voice communication process will be described in detail later.

The first processor 130 may be responsible for controlling the card controller 160 as a main core. The first processor 130 and the second processor 140 may perform status signal intercommunication through general-purpose input-output (GPIO) ports. The status signal here may include an operating status, e.g., whether the operating status of the second processor 140 is normal, hibernate-awake, etc.

The application program processor 150 may be configured to handle complex logic operations and perform task assignments, etc.

The first processor 130 and the second processor 140 may transmit application data to the application program processor 150 through USB/SDIO, and other methods.

The terminal 100 according to the embodiments of the present invention may further include a memory (not shown in FIG. 1). Multiple operating systems may be stored in the memory. The operating systems may include, but are not limited to, Windows, Linux, UNIX, Mac OS X, IOS, Solaris, Android, etc. The operating system may be processed by the application program processor 150, and the operating system may include a driver layer, a kernel layer, and a user layer. Among them, the kernel layer may include a network interface layer, a network layer, a TCP/UDP interface, and a kernel interface.

In one embodiment of the present invention, data routing of dual data channels in the kernel may be implemented in a TCP/IP flow-oriented manner to achieve the goal of increasing the bandwidth.

In one embodiment of the present invention, the pins of the user identification card may include a power pin (VCC pin), a reset pin (RST pin), a clock pin (CLK pin), and an input/output pin (DATA I/O pin), etc.

When activating/cold resetting the user identification card, after the clock is added, the reset pin may be held at a low voltage level for a preset time (for example, the preset time may be 400 T cycles). As such, the user identification card may be reset.

The reset response may start tc time after when the reset pin changes to a high voltage level, and tc may be between 400 T and 40000 T (T is the period).

When hot resetting the user identification card, as VCC and CLK remain stable, RST may be set to a low voltage level for at least to time, and the user identification card may start a hot reset.

According to the embodiments of the present invention, the reset response may start tf time after RST changes to a high voltage level H, and tf may be between 400 T and 40000 T periods. When the physical layer (L1 layer) completes the switch of the user identification card between the two processors, it will inevitably lead to the VCC pin (cold reset) and the RST pin (hot reset) becoming disconnected. A reset operation may be required when the user identification card is accessed again. The reset time may require at least 800 T period time. Therefore, in order to reduce the number of resets, according to the embodiments of the present invention, the switching operation of the user identification card may be performed during a long waiting period that the terminal needs to access the user identification card.

According to the embodiments of the present invention, the first processor 130 may be configured to, when intercommunication with the first user identification card and the second user identification card is needed, generate an access request. The first processor 130 may further be configured to, based on the access request, query the access permission of the user identification card and, in response to having the access permission of the user identification card, control the connection path of the user identification card and the first processor 130 to be turned on to implement the intercommunication between the first processor 130 and the user identification card. The second processor 140 may be configured to, when intercommunication with the first user identification card and the second user identification card is needed, generate an access request and send the access request to the first processor 130; the first processor may further be configured to, based on the access request, query the access permission of the user identification card and, in response to having the access permission of the user identification card, control the connection path of the user identification card and the second processor 140 to be turned on to implement the intercommunication between the second processor 140 and the user identification card.

Whether or not having the access permission of the user identification card may refer to whether the user identification card is being accessed by another processor, i.e., whether the user identification card is free. For example, if the first user identification card is connected to the first processor for data services, the second processor may not have the access permission of the first user identification card. In one embodiment, in response to not having the access permission, the access request may be stored in a message queue, and the access permission may be re-queried when a preset condition is satisfied. For example, the preset condition may be receiving a notification for re-acquiring the access permission of the user identification card.

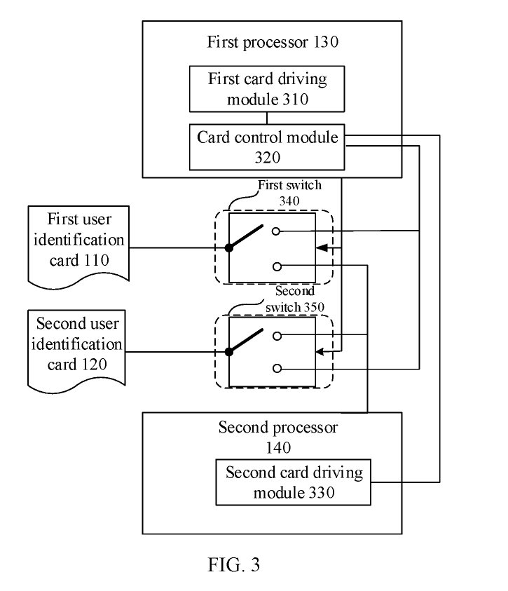

Referring to FIG. 3, in one embodiment of the present invention, the first processor 130 may include a first card driving module 310 and a card control module 320. The second processor 140 may include a second card driving module 330. The card controller 160 may include a first switch 340 and a second switch 350.

The first card driving module 310 may be configured to, when the first processor 130 needs to intercommunicate with the first user identification card or the second user identification card, generate an access request and send the access request to the card control module 320, and may also be configured to, when no card intercommunication instruction is received within a first preset time, send a release request to the card control module 320. The card intercommunication instruction may refer to a command generated when intercommunicating with the user identification card, for example, when reading the contact of the card, initializing the card, etc.

The card control module 320 may be configured to, based on the access request sent by the first card driving module 310, output a control message to control the first switch 340 to turn on the connection path between the first user identification card 110 and the first processor 130, and/or control the second switch 350 to turn on the connection path between the second user identification card 120 and the first processor 130.

The card control module 320 may be configured to, based on the release request sent by the first card driving module 310, output a control message to control the first switch 340 to turn off the connection path between the first user identification card 110 and the first processor 130, and/or control the second switch 350 to turn off the connection path between the second user identification card 120 and the first processor 130.

The second card driving module 330 may be configured to, when the second processor 140 needs to intercommunicate with the first user identification card or the second user identification card, generate an access request and send the access request to the card control module 320, and may also be configured to, when no card intercommunication instruction is received within a second preset time, send a release request to the card control module 320.

The card control module 320 may be configured to, based on the access request sent by the second card driving module 330, output a control message to control the first switch 340 to turn on the connection path between the first user identification card 110 and the second processor 140, and/or control the second switch 350 to turn on the connection path between the second user identification card 120 and the second processor 140.

The card control module 320 may be configured to, based on the release request sent by the second card driving module 330, output a control message to control the first switch 340 to turn off the connection path between the first user identification card 110 and the second processor 140, and/or control the second switch 350 to turn off the connection path between the second user identification card 120 and the second processor 140.

In one embodiment, the card control module 320 may intercommunicate with the first card driving module 310 and the second card driving module 330 through Rsp and Ind messages.

In one embodiment, when the first card driving module 310 does not receive (or detect) any card communication instruction within the first preset time (within a period of timer1), the user identification card may be released. When the second card driving module 330 does not receive (or detect) any card communication instruction within the second preset time (within a period of timer2), the user identification card may be released.

In the embodiment of the present invention, timer1 and timer2 may have different values, such that the two processors may have different priorities for accessing the user identification card. Specifically, the shorter the preset time, the shorter the time interval for detecting the card communication instruction, i.e., the higher the priority.

In one embodiment, the card control module 320 may maintain four state machines (00, 01, 10, 11) corresponding to the first user identification card and the second user identification card, respectively. Among them, corresponding to the first user identification card, 00 may indicate that neither processor needs to access the first user identification card, 01 may indicate that the second processor needs to access the first user identification card, 10 may indicate that the first processor needs to access the first user identification card, and 11 may indicate that both processors need to access the first user identification card. Corresponding to the second identification identity card, 00 may indicate that neither processor needs to access the second user identification card, 01 may indicate that the second processor needs to access the second user identification card, 10 may indicate that the first processor needs to access the second user identification card, and 11 may indicate that both processors need to access the second user identification card.

The card control module 320 may control the first switch 340 and the second switch 350 according to the state machine. Specifically, for example, in the 00 state, no switching is needed; when the first user identification card is in the 01 state, the second switch 350 may be controlled to turn on the connection path between the second processor and the first user identification card.

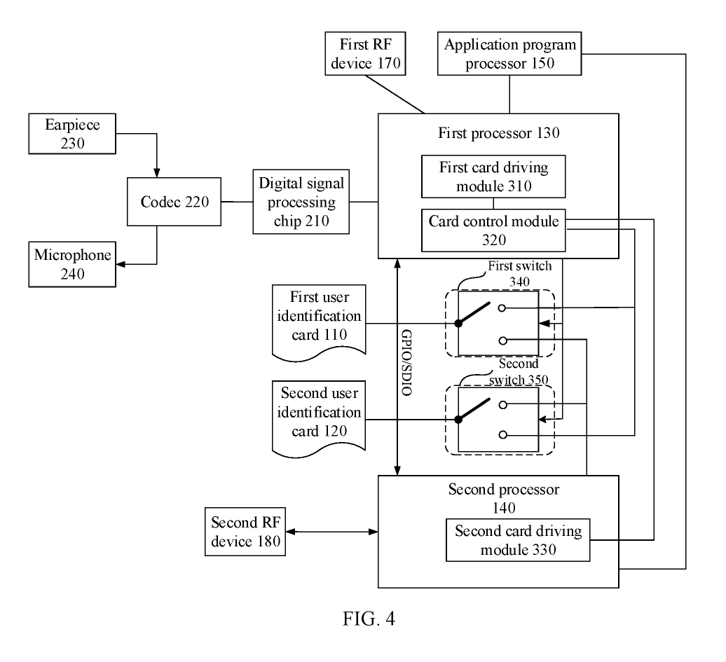

FIG. 4 illustrates a schematic diagram of a hardware structure of a terminal according to an embodiment of the present invention. In the embodiment, the application program processor 150 may provide a user intercommunication interface and receive user's operation instructions. The first processor 130 may be configured to output the first control instruction and the second control instruction according to the user's operation instructions.

The first switch 340 may be configured to turn on the connection path between the first user identification card 110 and the first processor 130 or the second processor 140 according to the first control instruction.

The second switch 350 may be configured to turn on the connection path between the second user identification card 1120 and the first processor 130 or the second processor 140 according to the second control instruction.

When the first user identification card 110 or the second user identification card 120 is connected to the first processor 130, the first processor 130 may be further configured to establish a communication connection with the 4G network.

When the first user identification card 110 or the second user identification card 120 is connected with the second processor 140, the second processor 140 may be configured to establish a communication connection with the 4G network.

When the connection path between the first user identification card is turned on, the first user identification card may be connected with the first processor or the second processor, and the transmission of services (data and/or voice services) may be implemented through the first user identification card.

When the connection paths for the first user identification card and the second user identification card are simultaneously turned on, the first user identification card may be connected with the first processor, and the second user identification card may be connected with the second processor. As such, concurrent data service transmission may be implemented through both the first user identification card and the second user identification card; or voice service transmission and data service transmission may be implemented through the first user identification card and the second user identification card, respectively; or voice service transmission and data service transmission may be implemented through the second user identification card and the first user identification card, respectively; or voice service transmission may be implemented through the first user identification card while concurrent data service transmission may be implemented through both the first user identification card and the second user identification card.

Referring to FIG. 4, in one embodiment of the present invention, the application program processor 150 may receive a user's operation instruction. When the operation instruction is to provide CS voice services through the first user identification card 110, the first processor 130 may output a first control instruction to control a first card switch controller 410 such that the first user identification card 110 may be connected to the first processor 130. The process of performing CS voice services through the first user identification card 110 may include the followings.

First, a voice communication connection may be established: the application program processor 150 may transmit the operation instruction to the first processor 130, and through a procedure, such as sending a radio resource control (RRC) connection request from the first RF device 170 to an Evolved Node B (eNodeB), a voice communication connection with the called party may be established.

After the voice communication connection is established, the voice uplink transmission process may be as follows: the microphone 240 may collect voice signals, and the codec 220 may receive the collected voice signals, and transmit the signals to the digital signal processing chip 210 after performing analog-to-digital conversion; the digital signal processing chip 210 may perform audio processing on the received signals, and transmit the processed signals to the first processor 130; the first RF device 170 may output the signals processed by the first processor 130. The voice downlink transmission process may be as follows: the first RF device 170 may receive the downlink signals and transmit the downlink signals to the first processor 130; the digital signal processing chip 210 may perform audio processing on the signals processed by the first processor 130 and transmit the signals to the codec 220; the codec 220 may perform digital-to-analog conversion on the received signals and transmit the signals to the earpiece 230.

Referring to FIG. 4, the application program processor 150 may receive a user's operation instruction. When the operation instruction is to provide CS voice services through the second user identification card 120, the first processor 130 may output a second control instruction to control a second card switch controller 420 such that the second user identification card 120 may be connected to the first processor 130. The process of performing CS voice services through the second user identification card 120 may include the followings.

First, a voice communication connection may be established: the application program processor 150 may transmit the operation instruction to the first processor 130, and through a procedure, such as sending a radio resource control (RRC) connection request from the first RF device 170 to an eNodeB, a voice communication connection with the called party may be established.

After the voice communication connection is established, the voice uplink transmission process may be as follows: the microphone 240 may collect voice signals, and the codec 220 may receive the collected voice signals, and transmit the signals to the digital signal processing chip 210 after performing analog-to-digital conversion; the digital signal processing chip 210 may perform audio processing on the received signals, and transmit the processed signals to the first processor 130; the first RF device 170 may output the signals processed by the first processor 130. The voice downlink transmission process may be as follows: the first RF device 170 may receive the downlink signals and transmit the downlink signals to the first processor 130; the digital signal processing chip 210 may perform audio processing on the signals processed by the first processor 130 and transmit the signals to the codec 220; the codec 220 may perform digital-to-analog conversion on the received signals and transmit the signals to the earpiece 230.

The application program processor 150 may receive user's operation instructions. When the operation instruction is to provide PS data services through the first user identification card 110, the first processor 130 may output a first control instruction to control the first card switch controller 410 to turn on the connection path between the first user identification card 110 and the first processor 130, and also output a second control instruction to control the first card switch controller 410 to turn on the connection path between the first user identification card 110 and the second processor 140. Both operations may be able to implement the transmission of PS data services.

Specifically, when the connection path between the first user identification card 110 and the first processor 130 is turned on, the transmission flow of the PS data services is: an application service module may receive data and transmit the data to the first processor; the first RF device may transmit the uplink signals after being processed by the first processor to a first network (4G network), and receive the downlink signals from the first network (4G network) and transmit the downlink signals to the first processor for processing; an application processing module may output the downlink signals after being processed by the first processor.

When the connection path between the first user identification card 110 and the second processor 140 is turned on, the transmission flow of the PS data services is: the application service module may receive data and transmit the data to the second processor; the first RF device 170 may transmit the uplink signals after being processed by the second processor to an LTE network, and receive the downlink signals from the LTE network and transmit the downlink signals to the second processor for processing; the application processing module may output the downlink signals after being processed by the second processor.

When the operation instruction is to perform PS data services through the second user identification card 120, the first processor 130 may output the first control instruction to control the second card switch controller 420 to turn on the connection path between the second user identification card 120 and the first processor 130, and also output a second control instruction to control the second card switch controller 420 to turn on the connection path between the second user identification card 120 and the second processor 140. Both operations may be able to implement the transmission of PS data services.

Specifically, when the connection path between the second user identification card 120 and the first processor 130 is turned on, the transmission flow of the PS data services is: an application service module may receive data and transmit the data to the first processor; the first RF device may transmit the uplink signals after being processed by the first processor to a first network (4G network), and receive the downlink signals from the first network (4G network) and transmit the downlink signals to the first processor for processing; an application processing module may output the downlink signals after being processed by the first processor.

When the connection path between the second user identification card 120 and the second processor 140 is turned on, the transmission flow of the PS data services is: the application service module may receive data and transmit the data to the second processor; the first RF device 170 may transmit the uplink signals after being processed by the second processor to a second network (4G network), and receive the downlink signals from the second network (4G network) and transmit the downlink signals to the second processor for processing; the application processing module may output the downlink signals after being processed by the second processor. Because after the user device is turned on, the user device may intercommunicate with the user identification card once every 28 seconds to confirm whether the user identification card is in place, and thus ensure that the communication is normal. The 28-second communication may be controlled by the processor connected to the user identification card. For example, the processor may send a null data to the user identification card, and when a response is received, the user identification card may be confirmed to be in place, otherwise the user identification card may not be in place.

In the embodiments of the present invention, the first processor 130 may be further configured to send messages to the first user identification card 110 or the second user identification card 120 at a preset time interval to confirm whether the user identification card is in place.

When confirming whether the first user identification card 110 is in place (assuming that the first user identification card 110 needs to be connected with the first processor 130), in response to that the first user identification card 110 is not connected to the first processor 130, the first processor 130 may be further configured to output a first control instruction to control the first card switch controller 410 to turn on the connection path between the first user identification card 110 and the first processor 130.

When confirming whether the second user identification card 120 is in place (assuming that the second user identification card 120 needs to be connected with the first processor 130), in response to that the second user identification card 120 is not connected to the first processor 130, the first processor 130 may be further configured to output a second control instruction to control the second card switch controller 420 to turn on the connection path between the second user identification card 120 and the first processor 130.

Similarly, the second processor 140 may be further configured to send messages to the first user identification card 110 or the second user identification card 120 at a preset time interval to confirm whether the user identification card is in place.

When confirming whether the first user identification card 110 is in place (assuming that the first user identification card 110 needs to be connected with the second processor 140), in response to that the first user identification card 110 is not connected to the second processor 140, the first processor 130 may be further configured to output a first control instruction to control the first card switch controller 410 to turn on the connection path between the first user identification card 110 and the second processor 140.

When confirming whether the second user identification card 120 is in place (assuming that the second user identification card 120 needs to be connected with the second processor 140), in response to that the second user identification card 120 is not connected to the second processor 140, the first processor 130 may be further configured to output a second control instruction to control the second card switch controller 420 to turn on the connection path between the second user identification card 120 and the second processor 140.

For example, when the second user identification card 120 originally connected to the second processor is switched to the first processor 130 (e.g. switched to the first processor 130 for PS data services), it may need to be switched back to the second processor every 28 seconds. That is, by controlling the second card switch controller 420, the second user identification card 120 may be connected to the second processor to complete the confirmation on whether the second user identification card is in place. After the card reading and confirmation is completed, the second user identification card may be switched back to the first processor again to ensure normal communication. Similarly, when the first user identification card 110 originally connected to the first processor is switched to the second processor 140, it may need to be switched back to the first processor every 28 seconds. That is, by controlling the first card switch controller 410, the first user identification card 110 may be connected to the first processor to complete the confirmation on whether the first user identification card is in place. After the card reading and confirmation is completed, the first user identification card may be switched back to the second processor again to ensure normal communication.

It should be understood that the switching time of the card switch controllers may be in the order of milliseconds, and the card reading time during the in-position confirmation process may also be in the order of milliseconds. Therefore, the switching of the user identification card may not affect the normal service transmission.

It should be understood that, in some embodiments, through priority setting, the priority of the voice services may be set to be higher than the priority of the data services such that, during the process of confirming whether the user identification card is in place, normal operation of the voice services may be preferentially ensured.

According to the in-position confirmation mechanism described above, for a terminal consistent with the embodiments of the present invention, when the first user identification card 110 is connected to the second processor 140 for data service transmission, the first user identification card 110 may also be simultaneously connected with the first processor 130 for voice service transmission. It may only require to ensure that the first user identification card 110 is in place during the in-position confirmation process.

According to the in-position confirmation mechanism described above, for a terminal consistent with the embodiments of the present invention, when the second user identification card 120 is connected to the second processor 140 for data service transmission, the second user identification card 120 may also be simultaneously connected with the first processor 130 for voice service transmission. It may only require to ensure that the second user identification card 120 is in place during the in-position confirmation process.

According to the in-position confirmation mechanism described above, for a terminal consistent with the embodiments of the present invention, when the first user identification card 110 is connected with the first processor 130 for data service transmission and voice services, the second user identification card 120 may also be connected to the second processor 140 for data service transmission. It may only require to ensure that the first user identification card 110 and the second user identification card 120 are respectively in place during the in-position confirmation process.

According to the in-position confirmation mechanism described above, for a terminal consistent with the embodiments of the present invention, when the second user identification card 120 is connected with the first processor 130 for data service transmission and voice services, the first user identification card 110 may also be connected to the second processor 140 for data service transmission. It may only require to ensure that the first user identification card 110 and the second user identification card 120 are respectively in place during the in-position confirmation process.

In one embodiment of the present invention, the first user identification card and the second user identification card may both be 4G cards, for example, in the LET standard or other type of 4G standards.

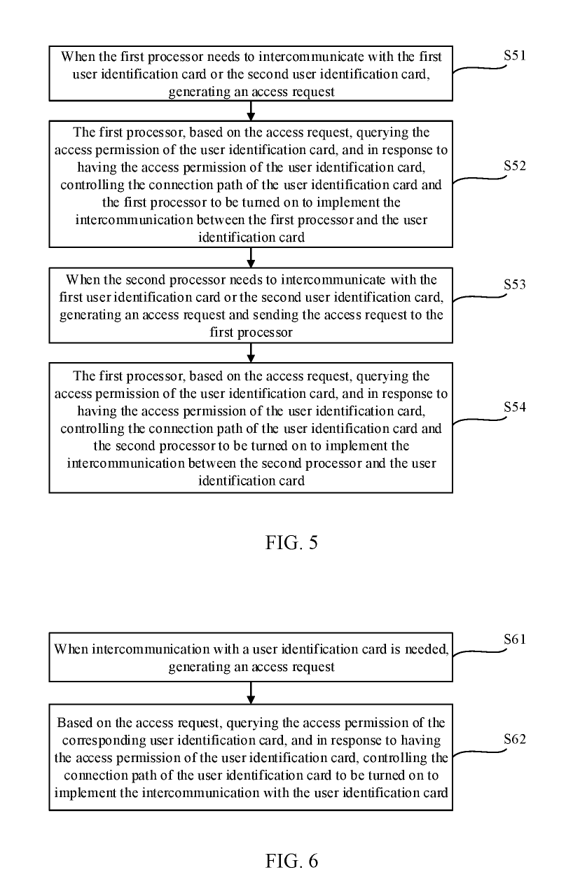

Referring to FIG. 5, accordingly, the embodiments of the present invention also provide a user identification card control method, applied to a terminal including a first user identification card and a second user identification card. The terminal may further include a first processor, and the method may include:
S51, when the first processor needs to intercommunicate with the first user identification card or the second user identification card, generating an access request;
S52, the first processor, based on the access request, querying the access permission of the user identification card and, in response to having the access permission of the user identification card, controlling the connection path of the user identification card and the first processor to be turned on to implement the intercommunication between the first processor and the user identification card.

The terminal may further include a second processor connected to the first processor, and the method may further include:
S53, when the second processor needs to intercommunicate with the first user identification card or the second user identification card, generating an access request and sending the access request to the first processor;
S54, the first processor, based on the access request, querying the access permission of the user identification card and, in response to having the access permission of the user identification card, controlling the connection path of the user identification card and the second processor to be turned on to implement the intercommunication between the second processor and the user identification card.

When the connection path between the second processor and the first user identification card or the second user identification card is turned on, but intercommunication with the card is not performed within a second preset time, the connection path is released.

When the connection path between the first processor and the first user identification card or the second user identification card is turned on, but intercommunication with the card is not performed within a first preset time, the connection path is released.

Based on the access request, when determining not having the access permission of the corresponding user identification card, the access request may be put into a message queue, and when a preset condition is satisfied, the access permission may be re-queried.

It should be understood that the specific implementation details and principles described in the foregoing implementation can be applied to the user identification card control method, and the details are not described herein again.

Referring to FIG. 6, the embodiments of the present invention provide a user identification card control method, including:
S61, when intercommunication with a user identification card is needed, generating an access request;
S62, based on the access request, querying the access permission of the corresponding user identification card and, in response to having the access permission of the user identification card, controlling the connection path of the user identification card to be turned on to implement the intercommunication with the user identification card.

The embodiments of the present invention provide a computer storage medium. The computer storage medium may store computer-executable instructions. The computer-executable instructions may include:
when the first processor needs to intercommunicate with the first user identification card or the second user identification card, generating an access request;
the first processor, based on the access request, querying the access permission of the user identification card and, in response to having the access permission of the user identification card, controlling the connection path of the user identification card and the first processor to be turned on to implement the intercommunication between the first processor and the user identification card.

In one embodiment, the computer-executable instructions may further include:
when the second processor needs to intercommunicate with the first user identification card or the second user identification card, generating an access request and sending the access request to the first processor;
the first processor, based on the access request, queries the access permission of the user identification card and, in response to having the access permission of the user identification card, controls the connection path of the user identification card and the second processor to be turned on to implement the intercommunication between the second processor and the user identification card.

In one embodiment, the computer-executable instructions may further include:
when the connection path between the second processor and the first user identification card or the second user identification card is turned on, but intercommunication with the card is not performed within a second preset time, the connection path is released.

In one embodiment, the computer-executable instructions may further include:
when the connection path between the first processor and the first user identification card or the second user identification card is turned on, but intercommunication with the card is not performed within a first preset time, the connection path is released;
based on the access request, when determining not having the access permission of the corresponding user identification card, the access request may be put into a message queue, and when a preset condition is satisfied, the access permission may be re-queried.

The embodiments of the present invention also provide a computer storage medium. The computer storage medium may store computer-executable instructions. The computer-executable instructions may include:
when intercommunication with a user identification card is needed, generating an access request;
based on the access request, querying the access permission of the corresponding user identification card and, in response to having the access permission of the user identification card, controlling the connection path of the user identification card to be turned on to implement the intercommunication with the user identification card.

In one embodiment, the computer-executable instructions may also include that after the connection path of the user identification card is turned on, when no card intercommunication instruction is received within a preset time, the connection path is released.

It should be understood that the specific implementation details and principles described in the foregoing implementation can be applied to the computer storage medium, and details are not described herein again.

The terminal and the user identification card control method according to the embodiments of the present invention may allow two processors to control and intercommunicate with two user identification cards, and thus flexible access to the user identification cards by the two processors may be achieved. Therefore, dual 4G is supported, which improves the user experience; data service transmission by dual 4G is supported, which greatly improves the data transmission speed; and through the switching between user identification cards, CS voice services of the first user identification card and the second user identification card can be both processed by the first processor, and thus only one codec and one digital signal processing chip are required. Logic for voice intercommunication between two processing chips is not required, data (voice) transmission between two processing chips is not required, and the cost of software and hardware is reduced.

In the embodiments of the present invention, unless otherwise specified, the term “plurality” refers to two or more than two. In the description of the present invention, it should be understood that the terms “first”, “second”, etc. are used for descriptive purposes only and are not to be construed as indicating or implying relative importance.

Any process or method described in the flowcharts or described in other ways in the embodiments of the present invention may be understood as comprising one or more modules, segments, or sections of executable instruction code for implementing the steps of a specific logic function or process. In addition, the scope of the embodiments of the present invention include additional implementations, in which functions may be performed in an order different from the order shown or discussed, including a substantially simultaneous manner or a reverse order depending on the functionality involved. This should be understood by those skilled in the art according to the described embodiments of the present invention.

For illustrative purposes, the foregoing description uses specific terms to provide a thorough understanding of the present invention. However, it will be apparent to those skilled in the art that specific details may not be required in order to implement the invention. The foregoing description of specific embodiments of the invention has been presented for the purposes of illustration and description. They are not intended to be exhaustive or to limit the invention to the precise forms disclosed. In view of the above principles, many modifications and variations are possible. These embodiments are shown and described in order to best explain the principles of the invention and its practical applications, thereby enabling others skilled in the art to best utilize various embodiments of the present invention and modifications that are suitable for intended specific uses. It is intended that the scope of the invention is defined by the following claims and their equivalents.

The above descriptions is only the preferred embodiments of the present invention and is not intended to limit the protection scope of the present invention.

### INDUSTRIAL APPLICABILITY

By adopting the embodiment of the present invention, two processors may be able to control and intercommunicate with two user identification cards, and thus flexible access to the user identification cards by the two processors may be achieved. Therefore, dual 4G is supported, which improves the user experience; data service transmission by dual 4G is supported, which greatly improves the data transmission speed; and through the switching between user identification cards, CS voice services of the first user identification card and the second user identification card can be both processed by the first processor, and thus only one codec and one digital signal processing chip are required. Logic intercommunication between two processing chips is not required, data (voice) transmission between two processing chips is not required, and the cost of software and hardware is reduced.

1. A user identification card control method, applied to a terminal including a first user identification card and a second user identification card, wherein the terminal includes a first processor; and the method includes:
when intercommunicating with the first user identification card or the second user identification card, generating, by the first processor, an access request;
based on the access request, querying, by the first processor, access permission of the user identification card and, in response to having the access permission of the user identification card, controlling a connection path of the user identification card and the first processor to be turned on to implement intercommunication between the first processor and the user identification card.

2. The user identification card control method according to claim 1, wherein the terminal also includes a second processor connected to the first processor; and the method further includes:
when intercommunicating with the first user identification card or the second user identification card, generating, by the second processor, an access request and sending the access request to the first processor;
based on the access request, querying, by the first processor, the access permission of the user identification card and, in response to having the access permission of the user identification card, controlling a connection path between the user identification card and the second processor to be turned on to implement intercommunication between the second processor and the user identification card.

3. The user identification card control method according to claim 2, wherein the method further includes:
when the connection path between the second processor and the first user identification card or the second user identification card is turned on, but intercommunication with the card is not performed within a second preset time, releasing the connection path.

4. The user identification card control method according to claim 1, wherein the method further includes:
when the connection path between the first processor and the first user identification card or the second user identification card is turned on, but intercommunication with the card is not performed within a first preset time, releasing the connection path.

5. The user identification card control method according claim 1, wherein the method further includes:
based on the access request, when determining not having the access permission of the corresponding user identification card, putting the access request into a message queue, and waiting for a preset condition to be satisfied to re-query the access permission.

6. A terminal, comprising:
a first user identification card;
a second user identification card;
a first processor configured to, when intercommunicating with the first user identification card or the second user identification card, generate an access request;
wherein the first processor is further configured to, based on the access request, query access permission of the user identification card and, in response to having the access permission of the user identification card, control a connection path between the user identification card and the first processor to be turned on to implement the intercommunication between the first processor and the user identification card.

7. The terminal according to claim 6, wherein the terminal further includes a second processor connected to the first processor, and
the second processor is configured to, when intercommunicating with the first user identification card or the second user identification card, generate an access request and send the access request to the first processor;
wherein the first processor is further configured to, based on the access request, query the access permission of the user identification card and, in response to having the access permission of the user identification card, control a connection path between the user identification card and the second processor to be turned on to implement the intercommunication between the second processor and the user identification card.

8. The terminal according to claim 7, wherein the terminal further includes:
a card controller, wherein:
the card controller is connected with the first processor, the second processor, the first user identification card, and the second user identification card, respectively;
the card controller is configured to, based on control of the first processor, turn on the connection path between the first user identification card and the first processor and/or the second processor; and also configured to, based on the control of the first processor, turn on the connection path between the second user identification card and the first processor and/or the second processor.

9. The terminal according to claim 8, wherein the card controller includes a first switch and a second switch, wherein:
the first switch is connected with the first processor and the first user identification card, respectively;
the second switch is connected with the first processor and the second user identification card, respectively.

10. The terminal according to claim 9, wherein the first processor includes a first card driving module and a card control module, wherein:
the first card drive module is configured to, when the first processor intercommunicates with the first user identification card or the second user identification card, generate an access request and send the access request to the card control module; and also configured to, when no card intercommunication instruction is received within a first preset time, send a release request to the card control module;
the card control module is configured to, based on the access request sent by the first card drive module, output a control message to control the first switch to turn on the connection path between the first user identification card and the first processor, and/or control the second switch to turn on the connection path between the second user identification card and the first processor;
the card control module is configured to, based on the release request sent by the first card drive module, output a control message to control the first switch to turn off the connection path between the first user identification card and the first processor, and/or control the second switch to turn off the connection path between the second user identification card and the first processor.

11. The terminal according to claim 10, wherein the second processor includes a second card drive module, wherein:
the second card drive module is configured to, when the second processor intercommunicates with the first user identification card or the second user identification card, generate an access request and send the access request to the card control module; and also configured to, when no card intercommunication instruction is received within a second preset time, send a release request to the card control module;
the card control module is configured to, based on the access request sent by the second card drive module, output a control message to control the first switch to turn on the connection path between the first user identification card and the second processor, and/or control the second switch to turn on the connection path between the second user identification card and the second processor;
the card control module is configured to, based on the release request sent by the second card drive module, output a control message to control the first switch to turn off the connection path between the first user identification card and the second processor, and/or control the second switch to turn off the connection path between the second user identification card and the second processor.

12. The terminal according to claim 10, wherein:
the first processor is further configured to send a message to the first user identification card or the second user identification card at a preset time interval to determine whether the user identification card is in place;
when determining whether the first user identification card is in place, in response to the first user identification card not connected with the first processor, the first processor is further configured to send out a first control instruction to control the first switch to turn on the connection path between the first user identification card and the first processor;
when determining whether the second user identification card is in place, in response to the second user identification card not connected with the first processor, the first processor is further configured to send out a second control instruction to control the second switch to turn on the connection path between the second user identification card and the first processor.

13. The terminal according to claim 10, wherein:
the second processor is further configured to send a message to the first user identification card or the second user identification card at a preset time interval to determine whether the user identification card is in place;
when determining whether the first user identification card is in place, in response to the first user identification card not connected with the second processor, the first processor is further configured to send out a first control instruction to control the first switch to turn on the connection path between the first user identification card and the second processor;
when determining whether the second user identification card is in place, in response to the second user identification card not connected with the second processor, the first processor is further configured to send out a second control instruction to control the second switch to turn on the connection path between the second user identification card and the second processor.

14. A terminal, comprising a first user identification card and a second user identification card, and also including:
a first processor, configured to output a first control instruction and a second control instruction according to an operation instruction of a user;
a first switch, configured to turn on a connection path between the first user identification card and the first processor or the second processor according to the first control instruction;
a second switch, configured to turn on a connection path between the second user identification card and the first processor or the second processor according to the second control instruction, wherein:
when the first user identification card or the second user identification card is connected with the first processor, the first processor is further configured to establish a communication connection with a 4G network,
a second processor, configured to establish a communication connection with a 4G network when the first user identification card or the second user identification card is connected with the second processor.

15. The terminal according to claim 14, wherein:
when intercommunicating with the first user identification card or the second user identification card, the first processor is configured to generate an access request;
based on the access request, the first processor is configured to query the access permission of the user identification card and, in response to having the access permission of the user identification card, output the first control instruction and the second control instruction according to the operation instruction of the user.

16. The terminal according to claim 14, wherein:
when intercommunicating with the first user identification card or the second user identification card, the second processor is configured to generate an access request and send the access request to the first processor;
based on the access request, the first processor is configured to query the access permission of the user identification card and, in response to having the access permission of the user identification card, output the first control instruction and the second control instruction according to the operation instruction of the user.

17. The terminal according to claim 16, wherein:
when the connection path between the second processor and the first user identification card or the second user identification card is turned on, but intercommunication with the card is not performed within a second preset time, the connection path is released.

18. The terminal according to claim 15, wherein:
when the connection path between the first processor and the first user identification card or the second user identification card is turned on, but intercommunication with the card is not performed within a first preset time, the connection path is released.

19. The terminal according to claim 14, wherein:
the first processor is further configured to send a message to the first user identification card or the second user identification card at a preset time interval to determine whether the user identification card is in place;
when determining whether the first user identification card is in place, in response to the first user identification card not connected with the first processor, the first processor is further configured to send out the first control instruction to control the first switch to turn on the connection path between the first user identification card and the first processor;
when determining whether the second user identification card is in place, in response to the second user identification card not connected with the first processor, the first processor is further configured to send out the second control instruction to control the second switch to turn on the connection path between the second user identification card and the first processor.

20. The terminal according to claim 14, wherein:
the second processor is further configured to send a message to the first user identification card or the second user identification card at a preset time interval to determine whether the user identification card is in place;
when determining whether the first user identification card is in place, in response to the first user identification card not connected with the second processor, the first processor is further configured to send out the first control instruction to control the first switch to turn on the connection path between the first user identification card and the second processor;
when determining whether the second user identification card is in place, in response to the second user identification card not connected with the second processor, the first processor is further configured to send out the second control instruction to control the second switch to turn on the connection path between the second user identification card and the second processor.
